(19) United States
(12) Patent Application Publication
(10) Pub. No.: US 2014/0108514 A1
(43) Pub. Date: Apr. 17, 2014

(54) Method, Device, and System for Judging User Request

(71) Applicant: Huawei Technologies Co., Ltd., Shenzhen (CN)

(72) Inventor: Xiaohong Qi, Beijing (CN)

(73) Assignee: Huawei Technologies Co., Ltd., Shenzhen (CN)

(21) Appl. No.: 14/109,000

(22) Filed: Dec. 17, 2013

Related U.S. Application Data
(63) Continuation of application No. PCT/CN2011/083064, filed on Nov. 28, 2011.

(51) Int. Cl. H04L 29/08

(52) U.S. Cl. CPC H04L 67/327
USPC 709/203

(57) ABSTRACT

An embodiment of the present invention provides a method for judging a user request, including: receiving, by a content source server, a request message sent by a user equipment; and judging whether the request message carries a range of requested target object; if no, determine the request message as an initial user request; if yes, and if the range of the target object intersects the threshold, determining the request message as an initial user request; if the range of the target object does not intersect the threshold, determining the request message as a non-initial user request. An embodiment of the present invention further provides a device and a system for judging a user request.

### CROSS-REFERENCE TO RELATED APPLICATION

This application is a continuation of International Application No. PCT/CN2011/083064, filed on Nov. 28, 2011, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the communications field, and in particular, to a method, a device, and a system for judging a user request.

### BACKGROUND

With the development of the Internet and its applications, user equipment imposes higher and higher requirements on system response time of website system access, and reliability and real-timeness of website contents and services. Therefore, a system that uses a single server to support an entire website no longer meets user requirements. Instead, a cluster of servers of a two- or three-layer architecture is used to support the entire website.

The three-layer servers generally include layer 1: an edge server, which is directly related to a user equipment, provides the user equipment with a channel of accessing the network, and communicates with a content source server; layer 2: a middle layer, also known as a content source server, which is a server for providing content and may be a cache server or a server that stores original content; and layer 3: a back-end database server.

In some applications, the content source server needs to know whether a current user request is an initial user request so as to determine a priority level of the service object. In the prior art, by extending an existing standard file transfer protocol (or a data streaming protocol), the edge server notifies the content source server of the user request information, which imposes high requirements on both the edge server and the content source server.

### SUMMARY

Embodiments of the present invention provide a method, a device, and a system for judging a user request, which judge whether the user request is an initial user request without requiring both an edge server and a content source server to support extension of a transfer protocol.

An embodiment of the present invention provides a method for judging a user request, including: receiving, by a content source server, a request message sent by a user equipment; and judging whether the request message carries a range of requested target object; if no, determining the request message as an initial user request; and if yes, and, if the range of the target object intersects a threshold, determining the request message as an initial user request, or, if the range of the target object does not intersect the threshold, determining the request message as a non-initial user request.

The method for judging a user request in the embodiments of the present invention can judge whether the user request message carries a range of requested target object; if no, determine the request message as an initial user request; and, if yes, and, if the range of target object intersects a threshold, determine the request message as an initial user request, or, if the range of target object does not intersect the threshold, determine the request message as a non-initial user request. In this way, it is determined whether the user request is an initial user request without requiring both an edge server and a content source server to support extension of a transfer protocol, requirements on the equipment are reduced, and costs are saved.

### BRIEF DESCRIPTION OF THE DRAWINGS

FIG. 1 is a schematic diagram of a network structure according to an embodiment of the present invention;

FIG. 2 is a schematic flowchart of Embodiment 1;

FIG. 3 is a schematic flowchart of Embodiment 2;

FIG. 4 is a schematic flowchart of Embodiment 3;

FIG. 5 is a schematic flowchart of Embodiment 4;

FIG. 6 is a schematic structural diagram of a content source server according to Embodiment 5of the present invention;

FIG. 7 is a schematic structural diagram of a content source server according to Embodiment 6 of the present invention;

FIG. 8 is a schematic structural diagram of a system according to Embodiment 7; and

FIG. 9 is a schematic structural diagram of a system according to Embodiment 8.

### DETAILED DESCRIPTION

The following gives a brief description of the present invention so as to provide basic understanding on certain aspects of the present invention. It is understandable that the brief description is not an exhaustive description of the present invention. It neither intends to determine key or important parts of the present invention nor intends to restrict the scope of the present invention. It only intends to give certain concepts in a simplified manner, and serves as a preamble that precedes a more detailed description.

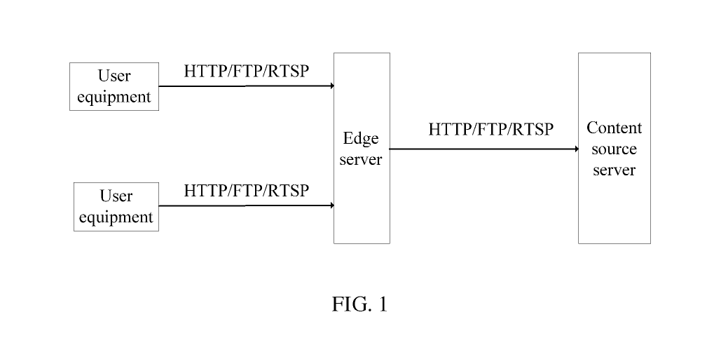

In the network architecture shown in FIG. 1, a user equipment sends a request message to a content source server by using a transfer protocol, so as to request to obtain the target object on the content source server. The target object mentioned in the embodiments of the present invention refers to content stored on the content source server and available for accessing and reading by the user equipment, and includes a target file and a target stream. The request message sent by the user equipment needs to pass through an edge server, and the edge server sends the request message of the user equipment to the content source server.

The user equipment generally sends the request message to the content source server by using a transfer protocol such as Hypertext Transfer Protocol (HTTP), File Transfer Protocol (FTP), or Real Time Streaming Protocol (RTSP).

Generally, an HTTP message is formed by a start line, one or more header fields, a blank line indicating end of a header field, and an optional message body. The header field of the HTTP includes four parts: a general header, a request header, a response header, and an entity header. Each header field is formed by a domain name, a colon (:), and a field value. The HTTP message may carry a range header field for specifying the start position and the end position of the range of the target file, for example, range: 200-300. The range header field can be used to request one or more sub-ranges of the target file. For example, the range header field indicates the first 500 bytes: bytes=0-499; or indicates the second 500 bytes: bytes=500-999; or indicates the last 500 bytes: bytes=−500; or indicates bytes after 500 bytes: bytes=500−; or indicates the first and last bytes: bytes=0-0, −1; or specifies several ranges concurrently: bytes=500-600, 601-999.

The FTP protocol is an 8-bit transfer protocol between the user equipment and the content source server. It can operate any type of file without further processing. A value carried in the REST command of the FTP protocol indicates that the target file request range is from the value to the end of the target file, and the target file of the content source server starts being transmitted from the value. For example, REST 10 in the FTP protocol indicates transmission of the target file from the 10th byte to the end of the file.

The RTSP defines how a one-to-many application transfers multimedia data through an Internet Protocol (IP) network efficiently. The RTSP protocol may also carry the range header field to indicate that a timestamp of the target stream on the content source server is requested. In the embodiments of the present invention, the timestamp refers to a time range of the requested target stream to be played.

In the embodiments of the present invention, a threshold T is preset on the content source server, where the threshold T is an interval that begins with a specific position of the target file or target stream requested by the user on the content source server. Different methods may be used to denote the threshold for different target files or target streams, and different start positions may be preset.

The threshold may be denoted by the number of bytes, and a corresponding range may be preset for the number of bytes according to actual requirements and is denoted by T=[s, t], where s indicates the start byte value of the range of the target file and t indicates the end byte value of the range of the target file. For example, T=[0, 199], indicating a range of 200 bytes that begin with the start position of the target file, where s is 0 and t is 199. For example, T=[0, 0], s=0, and t=0, indicating the initial position of the target object on the content source server.

The threshold may also be denoted by a timestamp, and, a corresponding play range may be set for the timestamp according to actual requirements and denoted by T=[s, t], where s indicates the start time value of the range of the target stream and t indicates the end time value of the range of the target stream. For example, T=[2, 200], indicating a play range from the 2nd second to the 200th second of the corresponding target stream, where s is 2 and t is 200. For example, T=[0, 0], s=0, and t=0s, indicating the start play position of the target stream on the content source server.

The threshold T is generally set according to statistics of user habits of requesting the target object on the content source server. That is, the initial user request generally requests the start range of the target object on the content source server. The content beyond this range is generally requested through a non-initial user request.

In this way, when multiple users request the same target file or target stream concurrently, if the request message sent by the user carries no range of the target file or target stream, the request message is determined as an initial user request according to the embodiments of the present invention; if the request message carries a range of the target file or target stream, a further judgment is made about whether the range of the target file or target stream in the request message intersects the threshold T, and, if an intersection exists, the request message is an initial user request, or, if the range of the target object does not intersect the threshold T, the request message is a non-initial user request.

In the embodiments of the present invention, the initial user request refers to a user request for accessing the target object initially; and a non-initial user request refers to a user request to access the target object before which the user has accessed the target object for at least one time.

In the embodiments of the present invention, it is assumed that a common standard file transfer protocol (such as HTTP and FTP) or a data streaming protocol (such as RTSP) is used to carry the range of requested target object, but the solutions of the present invention are not limited to the range given in the embodiments. When another transfer protocol capable of carrying the range of the target object is used to send the user request, the solutions of the present invention are also applicable.

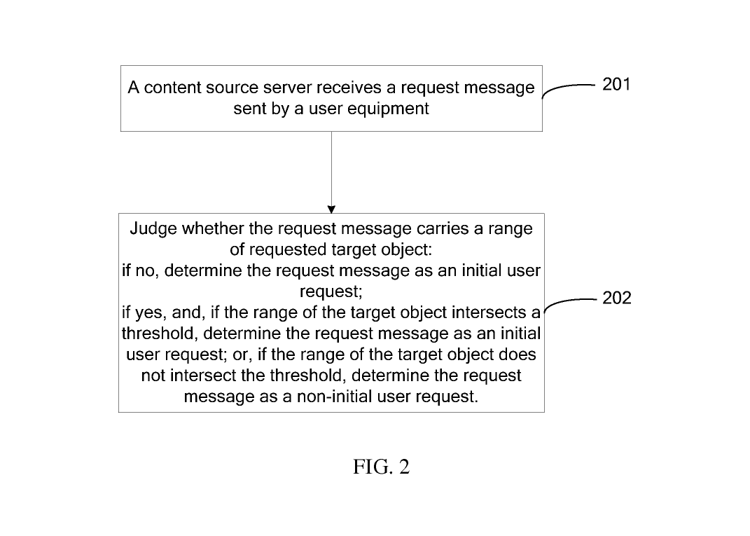

As shown in FIG. 2, Embodiment 1 of the present invention provides a method for judging a user request, including the following steps:

Step 201: A content source server receives a request message sent by a user equipment.

Optionally, the content source server uses an edge server to receive the request message sent by the user equipment.

Step 202: Judge whether the request message carries a range of requested target object: if no, determine the request message as an initial user request; if yes, and, if the range of the target object intersects a threshold, determine the request message as an initial user request; or, if the range of the target object does not intersect the threshold, determine the request message as a non-initial user request.

Optionally, the threshold is an interval that begins with a start position of the target object on the content source server.

More specifically, the interval that begins with the start position of the target object specifically includes a byte range that begins with a start position of a target file of a standard file transfer protocol request or a timestamp that begins with a start position of a target stream of a data streaming protocol request.

Optionally, the threshold is preset on the content source server.

Specifically, the request message uses a standard file transfer protocol or a data streaming protocol to carry the range of requested target object.

More specifically, when the standard file transfer protocol includes HTTP, or when the data streaming protocol includes RTSP, a range header field of the HTTP or RTSP carries the range of requested target object.

More specifically, when the standard file transfer protocol includes FTP, a REST command of the FTP carries the range of requested target object.

In this embodiment, a judgment can be made about whether the user request is an initial user request without requiring both an edge server and a content source server to support extension of a transfer protocol, thereby reducing requirements on the equipment and saving costs.

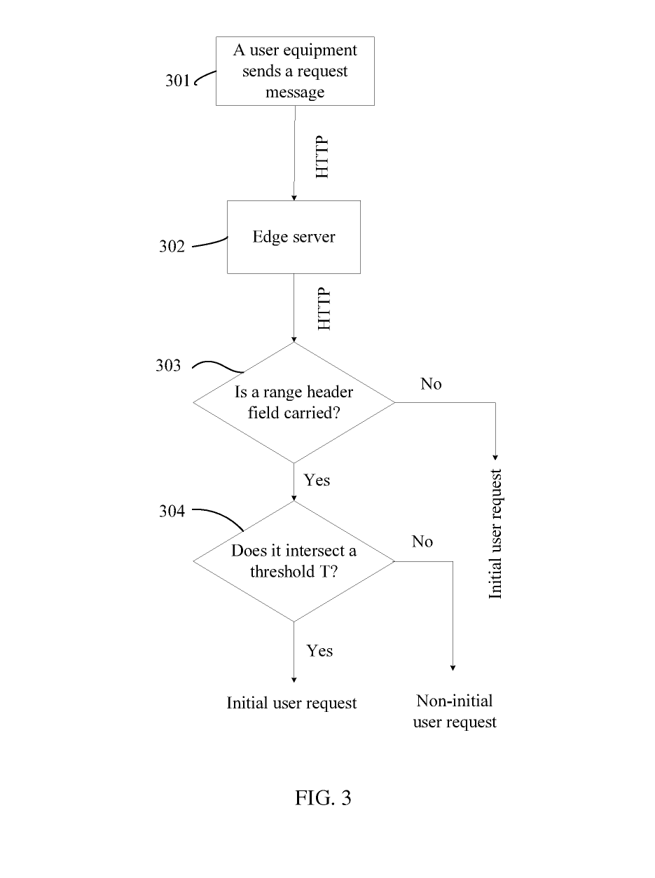

As shown in FIG. 3, Embodiment 2 of the present invention provides a method for judging a user request, including the following steps:

Step 301: A user equipment sends a request message.

Two user equipments use the HTTP protocol to send a request for the same target file to the content source server simultaneously, where the two user equipments are denoted by UE 1 and UE 2. In the user request message, a range header field may carry the range of the requested target file on the content source server.

For example, in the range header field of the request message from UE1, the range of the target file requested on the content source server is 300 bytes that begin with the start position of the file, expressed as bytes=0-299. In the range header field of the request message from UE2, the range of the target file requested on the content source server is a range after 500 bytes that begin with the start position, expressed as bytes=500−. The request message here may also carry no range of the target file.

Step 302: The user request message is sent by the edge server to the content source server.

The user request message is routed through the edge server to the content source server. The edge server is used to send the user request message in step 301 to the content source server.

Step 303: The content source server judges whether the user request message carries a range header field.

When the user request message carries no range header field, that is, carries no range of the target file, the user request is determined as an initial user request. Both user request messages in this embodiment carry the range header field, and therefore, the procedure proceeds to step 304.

Step 304: Judge whether the range intersects a threshold T.

The content source server may preset a threshold T for each target file separately depending on the provided target file, or may preset a uniform threshold T. The threshold T may be preset manually or preset by the content source server. The threshold T is variable, and the setting time is also variable. That is, the threshold T may be preset anytime before step 304. For example, the threshold T is preset to T=[0, 299], indicating a range of 300 bytes that begin with the start position of the target file on the content source server. Generally the threshold T is preset to [0, 0], which, however, does not mean that the threshold T necessarily begins with the start position of the target file. The start and the end of the threshold T may be preset as required. If the threshold T is preset to [0, 0], it indicates that the range begins with the first byte of the target file. In this embodiment, T=[0, 0] is taken as an example. The content source server judges whether the range of the target file in the range header field carried in the request message sent by the two users intersects the threshold T. If the intersection exists, the request message is determined as an initial user request; or, if no intersection exists, the request message is determined as a non-initial user request. The request message sent by the UE1 carries a range header field “bytes=0-299”, that is, the requested content is the first 300 bytes of the target file, and the threshold on the content source content is T=[0, 0], which are compared to show that the two intersect each other, and therefore, the user request sent by the UE1 is an initial user request. The request message sent by the UE2 carries a range header field “bytes=500−”, that is, the range of the target file is the content after the 500th byte, which is compared with the threshold T=[0, 0] to show that the two do not intersect, and therefore, the user request sent by the UE2 is determined as a non-initial user request. Evidently, the user request sent by the UE1 is the initial user request, and the user request sent by the UE2 is a non-initial user request.

The content source server in this embodiment includes at least one of, but not limited to, the original content server and the cache server.

In this embodiment, without changing the HTTP request protocol, the content source server compares the preset threshold T with the range of the target file carried in the range header field in the request protocol to judge whether the request message is an initial user request, which reduces the implementation difficulty, reduces requirements on the device, and saves costs.

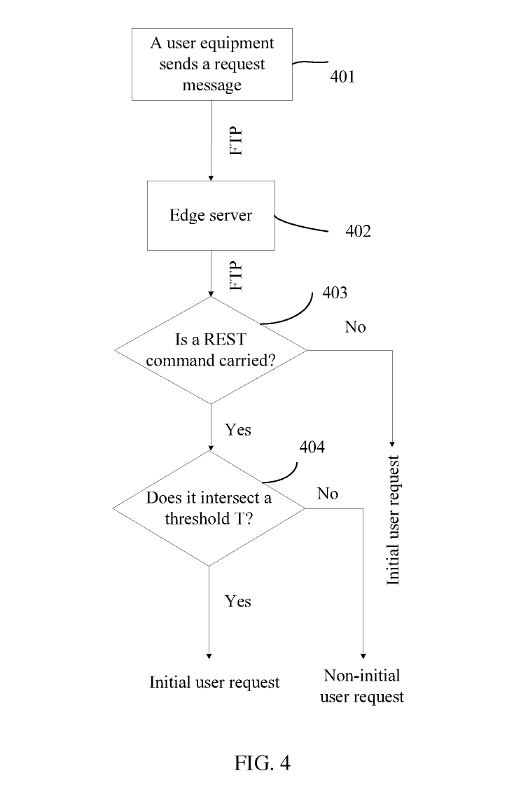

Embodiment 3 provides a method for judging a user request, which uses an FTP protocol to request a service from a content source server. As shown in FIG. 4, the method includes the following steps:

Step 401: A user equipment sends a request message.

Two user equipments use the FTP protocol to send a request for the same target file to the content source server, where the request may carry a REST command and the two user equipments are denoted by UE 1 and UE 2. The REST command indicates a need of reading a range from a specific byte of the target file to the end of the target file on the content source server.

The REST command carried in the UE1 request message is REST 20, indicating a reading range from the 20th byte of the target file to the end of the target file on the content source server, where the range is denoted by REST 20. The REST command carried in the UE2 request message is REST 0, indicating a reading range from the 0th byte of the target file to the end of the target file on the content source server, where the range is denoted by REST 0.

Step 402: The user request message passes through the edge server.

The user request message is routed through the edge server to the corresponding content source server, where the request is executed. The edge server is configured to send the user request message to the content source server.

Step 403: The content source server judges whether the user request message carries a REST command.

When the user request message carries no REST command, that is, no requested range of the target file, the user request is determined as an initial user request. Both user request messages in this embodiment of the present invention carry the REST command, and therefore, the procedure proceeds to step 404.

Step 404: Judge whether the range intersects a threshold T.

The content source server may preset a threshold T for each target file separately depending on the provided target file, or may preset a uniform threshold T. The threshold T may be preset manually or preset by the content source server. The threshold T is variable, and the setting time is also variable. That is, the threshold T may be preset anytime before step 404. For example, the threshold T is preset to T=[0, 199], indicating a range before the 200th byte of the corresponding target file on the content source server. Generally the threshold T is preset to [0, 0], which, however, does not mean that the threshold T necessarily begins with the start position of the target file. The start of the threshold T may be preset as required. T=[0, 0] indicates that the range begins with the first byte of the file. In this embodiment, T=[0, 0] is taken as an example. The content source server judges whether the range of the target file carried in the REST command of the two user request messages intersects the threshold T. If the intersection exists, the request message is determined as an initial user request; or, if no intersection exists, the request message is determined as a non-initial user request. The request message sent by the UE1 carries a REST command “REST 20”, and the threshold of the requested target file on the content source content is T=[0, 0], which are compared to show that the two do not intersect each other, and therefore, the request sent by the UE1 is a non-initial user request. The request message sent by the UE2 carries a REST command “REST 0”, which is compared with the threshold T=[0, 0] to show an intersection, and therefore, the request sent by the UE2 is an initial user request. The comparison result shows that the request sent by the UE1 is a non-initial user request, and the request sent by the UE2 is an initial user request.

The content source server in this embodiment includes at least one of, but not limited to, the original content server and the cache server.

In this embodiment, without changing the HTTP request protocol, the content source server compares the threshold T with the range of the target file in the REST command in the request protocol to judge whether the request message is an initial user request, which reduces the implementation difficulty, reduces requirements on the device, and saves costs.

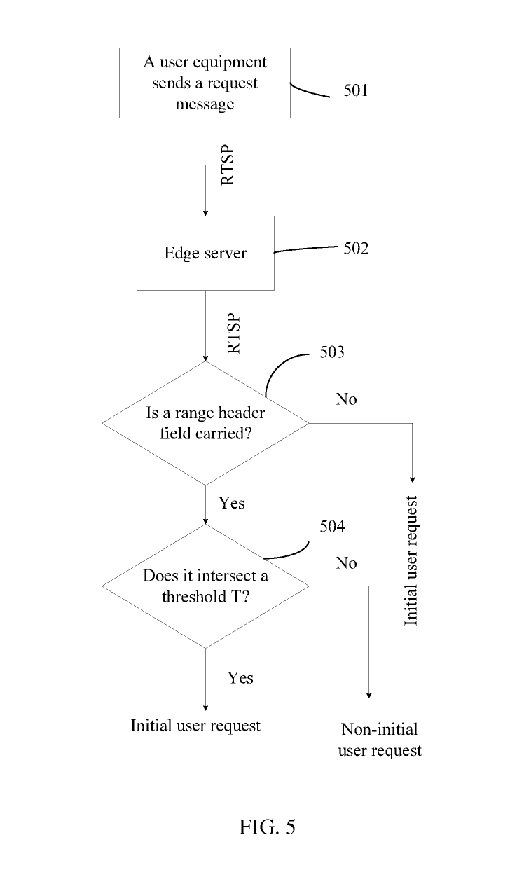

Embodiment 4 of the present invention provides a method for judging a user request, which uses an RTSP protocol to request a service from a content source server. As shown in FIG. 5, the method includes the following steps:

Step 501: A user equipment sends a request message.

The two user equipments use the RTSP protocol to send a request message for the same target stream on the content source server, where both of the request messages carry a range header field to indicate a play time range of reading the requested target stream on the content source server, that is, a timestamp of the stream. The two users are denoted by UE1 and UE2. The range header field of the UE1 carries a play range of the target stream on the content source server, where the play range begins with the start time position of the stream, expressed as range: npt=0.000−, requesting to play from the 0.000th second; and the UE2 requests to play from the 15th second, expressed as range: npt=15.000−.

Step 502: The user request message passes through the edge server.

The user request message is routed through the edge server to the corresponding content source server, where the corresponding user request is executed. The edge server is configured to send the two user request messages to the content source server.

Step 503: The content source server judges whether the user request message carries a range header field.

When the user request message carries no range header field, the user request is determined as an initial user request. Both user request messages in this embodiment carry the range header field, and therefore, the procedure proceeds to step 504.

Step 504: Judge whether the range intersects a threshold T.

The content source server may preset a threshold T for each target stream separately depending on the provided target stream, or may preset a uniform threshold T for the target streams on the content source server. The threshold T may be preset manually or preset by the server. The threshold T is variable, and the setting time is also variable. That is, the threshold T may be preset anytime before step 504. For example, the threshold T is preset to T=[0, 0], indicating that the user requests to play from the start position of the corresponding target stream on the content source server, that is, from the 0.00th second of the target stream. In this embodiment, T=[0, 0] is taken as an example, which, however, does not mean that the threshold T necessarily begins with the start position of the target file. The start of the threshold T may be preset as required. The content source server judges whether the range of the target stream in the range header field of the request message sent by the user equipment intersects the threshold T. If the intersection exists, the request message is determined as an initial user request; or, if no intersection exists, the request message is determined as a non-initial user request. The request message sent by the UE1 carries a range header field “npt=0.000−”, and the threshold on the content source content is T=[0, 0], which are compared to show that the two intersect each other, and therefore, the request sent by the UE1 is determined as an initial user request. The request message sent by the UE2 carries a range header field “npt=15.000−”, that is, the user requests to play the target stream from the 15.000th second of the target stream, which is compared with the threshold T=[0, 0] to show that the two do not intersect, and therefore, the request sent by the UE2 is determined as a non-initial user request. The comparison result shows that the request sent by the UE1 is an initial user request, and the request sent by the UE2 is a non-initial user request.

The content source server in this embodiment includes at least one of, but not limited to, the original content server and the cache server.

In this embodiment, without changing the RTSP request protocol, the content source server compares the preset threshold with the range of the target stream carried in the range header field in the request protocol to judge whether the request message is an initial user request, which reduces the implementation difficulty, reduces requirements on the device, and saves costs.

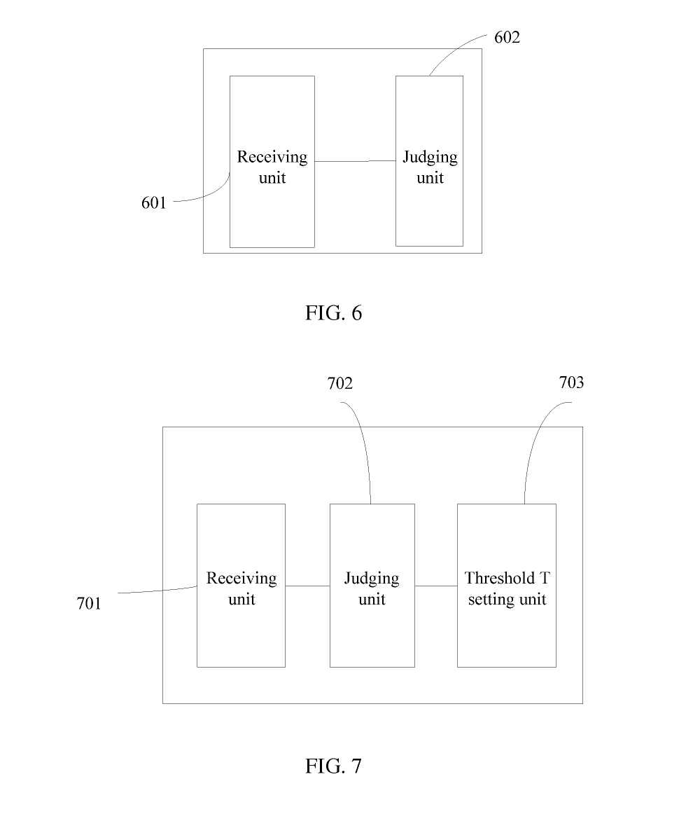

As shown in FIG. 6, Embodiment 5 of the present invention provides a content source server, including: a receiving unit 601 and a judging unit 602.

The receiving unit 601 is configured to receive a request message sent by a user equipment. The user request message may use a standard file transfer protocol or a data streaming protocol to carry the range of target object. The standard file transfer protocol includes HTTP and FTP. The data streaming protocol includes RTSP. When the standard file transfer protocol includes the HTTP and the data streaming protocol includes the RTSP protocol, the range header field of the HTTP or RTSP carries the range of the requested target object. When the standard file transfer protocol includes FTP, a REST command of the FTP carries the range of requested target object. Generally, the standard file transfer protocol for transferring the user request message includes the HTTP protocol and the FTP protocol, and the data streaming protocol for transferring the user request message is the RTSP protocol, which, however, shall not be construed as a limitation. The receiving unit 601 transfers the user request message to the judging unit 602 after receiving the user request message.

The judging unit 602 judges the user request message received by the receiving unit 601, and judges whether the user request message carries the range of the target object. If the user request message carries no range of the target object, the user request is determined as an initial user request. If the user request message carries the range of the target object, the judging unit 602 further compares the range of the target object in the user request message with a threshold T; and, if an intersection exists, determines the user request as an initial user request, or, if the range of the target object in the user request message does not intersect the threshold T, determines the request message as a non-initial user request. The threshold T is an interval that begins with a start position of the target object on the content source server. The threshold T is specifically a byte range that begins with a start position of a target file of a standard file transfer protocol request or a timestamp that begins with a start position of a target stream of a data streaming protocol request. Depending on actual requirements, the threshold T does not restrict the interval that begins with the start position of the target object. Depending on actual requirements, a specific position of the target object may be preset as the start position of the threshold T.

Without changing the request protocol, the content source server provided in this embodiment fulfills the effect of judging whether the user request is an initial user request, thereby reducing requirements on the equipment and saving costs.

Embodiment 6 of the present invention provides a content source server, including: a receiving unit 701, a judging unit 702, and a threshold T setting unit 703.

The receiving unit 701 is configured to receive a request message sent by a user equipment. The user request message may use a standard file transfer protocol or a data streaming protocol to carry the range of target object. The standard file transfer protocol includes HTTP and FTP. The data streaming protocol includes RTSP. When the standard file transfer protocol includes the HTTP and the data streaming protocol includes the RTSP protocol, the range header field of the HTTP or RTSP carries the range of the requested target object. When the standard file transfer protocol includes FTP, a REST command of the FTP carries the range of requested target object. Generally, the standard file transfer protocol for transferring the user request message includes the HTTP protocol and the FTP protocol, and the data streaming protocol for transferring the user request message is the RTSP protocol, which, however, shall not be construed as a limitation. The receiving unit 701 transfers the user request message to the judging unit 702 after receiving the user request message. The judging unit 702 judges the user request message received by the receiving unit 701, and judges whether the user request message carries the range of the target object. If the user request message carries no range of the target object, the user request is determined as an initial user request. If the user request message carries the range of the target object, the judging unit 702 further compares the range of the target object in the user request message with a threshold T; and, if an intersection exists, determines the user request as an initial user request, or, if the range of the target object in the user request message does not intersect the threshold T, determines the request message as a non-initial user request. The threshold T is an interval that begins with a start position of the target object on the content source server. The threshold T is specifically a byte range that begins with a start position of a target file of a standard file transfer protocol request or a timestamp that begins with a start position of a target stream of a data streaming protocol request. Depending on actual requirements, the threshold T does not restrict the interval that begins with the start position of the target object. Depending on actual requirements, a specific position of the target object may be preset as the start position of the threshold T.

The threshold T setting unit 703 is configured to preset the threshold for the target object on the content source server. The threshold T is generally preset according to the user habits of requesting the content source server. The threshold T setting unit 703 may preset the threshold T of the target object anytime before the judging unit 702 performs the judgment.

By presetting the threshold T, the content source server provided in this embodiment fulfills the effect of judging whether the user request is an initial user request, without changing the request protocol, thereby reducing requirements on the equipment and saving costs.

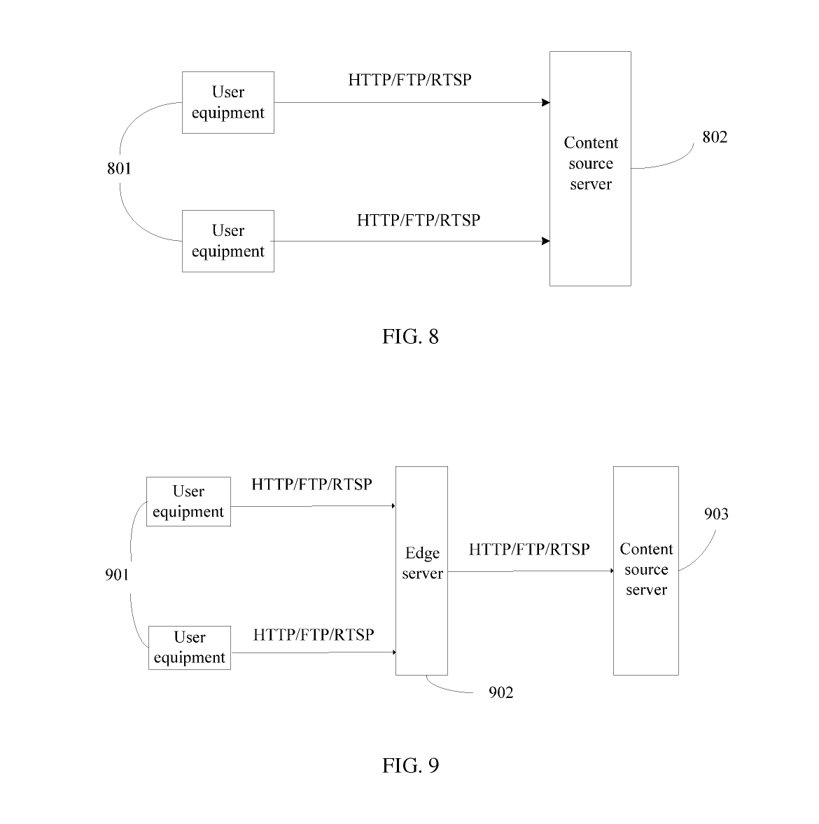

As shown in FIG. 8, Embodiment 7 of the present invention provides a system for judging a user request, including: a user equipment 801, and a content source server 802.

The user equipment 801 is configured to send a request message to the content source server 802. The user request message may use a standard file transfer protocol or a data streaming protocol to carry the range of target object. The standard file transfer protocol includes HTTP and FTP. The data streaming protocol includes RTSP. When the standard file transfer protocol includes the HTTP and the data streaming protocol includes the RTSP protocol, the range header field of the HTTP or RTSP carries the range of the requested target object. When the standard file transfer protocol includes FTP, a REST command of the FTP carries the range of requested target object. Generally, the standard file transfer protocol for transferring the user request message includes the HTTP protocol and the FTP protocol, and the data streaming protocol includes the RTSP protocol, which, however, shall not be construed as a limitation.

The content source server 802 judges whether the user request message sent by the user equipment 801 carries a range of requested target object; and, if the range of the target object is not carried, determines the user request as an initial user request; and, if the user request message carries the range of the target object, compares the range of the target object with the threshold T; if an intersection exists, determines the user request as an initial user request, or, if the range of the target object carried in the user request message does not intersect the threshold T, determines the user request as a non-initial user request. If the user request message carries the range of the requested target object and the user request message is transmitted by using the HTTP protocol or the RTSP protocol, the range header field of the HTTP or RTSP protocol may carry the range of the target object. The content source server 802 compares the range of the target object with the threshold T; and, if an intersection exists, determines the user request as an initial user request, or, if no intersection exists, determines the user request as a non-initial user request. If the user request message carries the range of the requested target object and the user request message is transmitted by using the FTP protocol, the REST command of the FTP protocol may carry the range of the target file. The content source server 802 compares the range of the target object with the threshold T; and, if an intersection exists, determines the user request as an initial user request, or, if no intersection exists, determines the user request as a non-initial user request. The content source server 802 includes at least one of, but not limited to, the cache server and the original content server.

In the system for judging a user request in this embodiment, without changing the request protocol and without requiring the content source server to support extension of the transfer protocol, the content source server judges whether the user request is an initial user request, thereby reducing requirements on the system equipment and saving costs.

As shown in FIG. 9, Embodiment 8 of the present invention provides a system for judging a user request, including: a user equipment 901, a content source server 903, and an edge server 902. The functions and effects of the user equipment 901 and the content source server 903 are respectively the same as the user equipment 801 and the content source server 802 in Embodiment 7 of the present invention. The edge server 902 is configured to send the user request message, which is sent by the user equipment 901, to the content source server 903.

In the system for judging a user request in this embodiment, without changing the request protocol and without requiring the content source server and the edge server to support extension of the transfer protocol, the content source server judges whether the user request is an initial user request, thereby reducing requirements on the system equipment and saving costs.

A person of ordinary skill in the art may appreciate that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to the corresponding process in the foregoing method embodiments, and the details will not be described herein again.

In the several embodiments provided in the present application, it should be understood that the disclosed system, apparatus, and method may be implemented in another manner. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

In addition, functional units in the embodiments of the present invention may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium and includes several instructions for instructing a computer device (which may be a personal computer, a server, or a network device) to perform all or a part of the steps of the methods described in the embodiments of the present invention. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for judging a user request, comprising:
receiving, by a content source server, a request message sent by a user equipment;
judging whether the request message carries a range of requested target object;
determining the request message as an initial user request when the request message does not carry the range of the requested target object;
determining the request message as an initial user request when the request message does carry the range of the requested target object and the range of the target object intersects a threshold; and
determining the request message as a non-initial user request when the range of the target object does not intersect the threshold.

2. The method according to claim 1, wherein the threshold is an interval that begins with a start position of the target object on the content source server.

3. The method according to claim 2, wherein the interval that begins with the start position of the target object specifically comprises a byte range that begins with a start position of a target file of a standard file transfer protocol request or a timestamp that begins with a start position of a target stream of a data streaming protocol request.

4. The method according to claim 1, wherein the threshold is preset on the content source server.

5. The method according to claim 1, wherein the request message uses a standard file transfer protocol or a data streaming protocol to carry the range of requested target object.

6. The method according to claim 5, wherein a range header field of Hyper Text Transfer Protocol (HTTP) or Real Time Streaming Protocol (RTSP) carries the range of the requested target object when the standard file transfer protocol comprises the HTTP or when the data streaming protocol comprises the RTSP.

7. The method according to claim 5, wherein a REST command of File Transfer Protocol (FTP) carries the range of requested target object when the standard file transfer protocol comprises the FTP.

8. The method according to claim 1, wherein the content source server receives the request message from the user equipment through an edge server.

9. A content source server, comprising:
a receiving unit configured to receive a request message sent by a user equipment; and
a judging unit configured to:
judge whether the request message carries a range of requested target object;
determine the request message as an initial user request when the request message does not carry the range of the requested target object;
judge whether the range of the target object intersects a threshold when the request message does carry the range of the requested target object;
determine the request message as an initial user request when the range of the target object intersects the threshold; and
determine the request message as a non-initial user request when the range of the target object does not intersect the threshold.

10. The content source server according to claim 9, wherein the threshold is an interval that begins with a start position of the target object on the content source server, and wherein the interval that begins with the start position of the target object specifically comprises a byte range that begins with a start position of a target file of a standard file transfer protocol request or a timestamp that begins with a start position of a target stream of a data streaming protocol request.

11. The content source server according to claim 9, further comprising a threshold setting unit configured to preset the threshold for the target object on the content source server.

12. The content source server according to claim 9, wherein the request message uses a standard file transfer protocol or a data streaming protocol to carry the range of requested target object.

13. The content source server according to claim 12, wherein a range header field of Hyper Text Transfer Protocol (HTTP) or Real Time Streaming Protocol (RTSP) carries the range of requested target object when the standard file transfer protocol comprises the HTTP or when the data streaming protocol comprises the RTSP.

14. The content source server according to claim 12, wherein a REST command of File Transfer Protocol (FTP) carries the range of requested target object when the standard file transfer protocol comprises the FTP.

15. A system for judging a user request, comprising:
a content source server; and
a user equipment configured to send a request message to the content source server,
wherein the content source server is configured to:
receive the user request message;
judge whether the request message carries a range of requested target object;
determine the request message as an initial user request when the request message does not carry the range of the requested target object;
determine the request message as an initial user request when the request message does carry the range of the requested target object and the range of the target object intersects a threshold; and
determine the request message as a non-initial user request when the range of the target object does not intersect the threshold.

16. The system according to claim 15, further comprising an edge server configured to send the user request message to the content source server.
